(19) United States
(12) Patent Application Publication
(10) Pub. No.: US 2007/0119309 A1
(43) Pub. Date: May 31, 2007

(54) Auxiliary water heater

(76) Inventors: Anol Carrington, Cape Coral, FL (US); Anna Marie Carrington, Cape Coral, FL (US)

Correspondence Address: Galasso & Associates LP, P.O. Box 26503, Austin, TX, 78755-0503, US

(21) Appl. No.: 11/290,318

(22) Filed: Nov. 30, 2005

(51) Int. Cl. A47J 31/00

(52) U.S. Cl. 99/279

(57) ABSTRACT

An auxiliary water heater that is installed in an area close to a faucet. This water heater is installed into the existing water line and serves to heat water flowing though the water line. It comprises a cylindrical shaped water tank that is encompassed within an oblong case. The cylindrical shaped water tank has a water input and a water output line. An electrical heating element is used to the heat water within the cylindrical water tank and the temperature of the hot water is controlled by a temperature control switch. Due to the placement of the auxiliary water heater, the amount of time it takes to receive hot water at a faucet is reduced and thereby reduces the amount of water that is wasted waiting for hot water.

### FIELD OF THE DISCLOSURE

An in-line water heater located close to the faucet for providing hot water to the faucet at a quicker pace.

### BACKGROUND

Running water in our homes in one thing that is taken for granted in most industralized countries these days. Water is also considered a renewable resource. However, depending on where you live, this renewable resource is not always as readily available as you might think. Alternatively, the cost you pay for this resource varies greatly.

Some places rely on snow from the mountains for their water. While this provides a good source of water, it is somewhat unpredictable. For example, if they have a mild winter, then the amount of snow they receive would be less. Consequently, when the snow melts the amount of water provided from the snow is less creating a water shortage. There is also the opposite effect, if you have too much snow, then the runoff during the melting season can be tremendous and create flooding, particularly if it is occurs during a period of extensive rain.

Other areas of the world depend on rain for their water source. This has its benefits and downfalls as well. Again, if you have a heavy rain season, then water is plentiful. If you have a very dry season, then water becomes less readily available. With rain, there must be a storage facility such as a lake for holding the water. While this provides an excellent source of water, the water is at risk for contamination.

Water contamination is a big concern when it comes to using it as drinking water. Water that is used from lakes, mountains and the like, all stand the risk of being contamination. This contamination can occur either at the source or along the route to ones house. While drinking water is treated prior to being pumped to houses, even this system has its own set of problems. For example, there are times when this water is potentially contaminated and a “boil alert” is issued. This can happen from sewage overflow during rain storms or from broken pipes. While everyone tries to keep drinking water as safe as possible it is not always perfect.

Even though water is a renewable resource, the cost of this renewable resource varies greatly from region to another and even one town from another. For example, there are areas where one's water bill may be relatively low per month. Then in other parts of the country or even another town that same water bill may run two or three times that much per month. Therefore, based on where you live, you may be more conservative with your water.

There are several ways that you can conserve water. Some of these ways are more acceptable than others. For example, taking a shower instead of a bath or turning the water off while brushing your teeth, instead of leaving it running. These are a couple of ways to save water.

One of the ways that we waste a lot of water is waiting for hot water. For example, no one wants to step into a shower that is running cold water so we turn the water on and wait for the hot water to arrive. Not only do we do this in the bathroom, but we do it a lot in the kitchen sink. Washing dishes in cold water is not nearly as effective as washing them in warm or hot water, so the water is turned on and runs down the drain unused until the hot water arrives. This is a total and complete waste of water that is now considered sewage and chemically treated.

### SUMMARY OF THE DISCLOSURE

In one embodiment the auxiliary water heater is comprised of a cylindrical shaped water tank.

In another embodiment the cylindrical shaped water tank is encompassed within an oblong case.

In still another embodiment the cylindrical shaped water tank is attached to a water input line.

In yet another embodiment the cylindrical shaped water tank is attached to a water output line.

In another embodiment the cylindrical shaped water tank is attached to the existing water lines.

In still another embodiment the auxiliary water heater comprises an electrical heating element.

In yet another embodiment the electrical heating element is operable to heat water within the cylindrical shaped water tank.

In another embodiment the auxiliary water tank comprises an element port.

In still another embodiment the element port is attached to said electrical heating element.

In yet another embodiment the said element port is operable to supply power to said electrical heating element.

In another embodiment the auxiliary water heater comprises an electrical flow switch

In still another embodiment the auxiliary water heater comprises at least one thermal overload heater.

In yet another embodiment the auxiliary water heater comprises a temperature control switch.

In another embodiment the water input and water output lines are comprised of copper.

In still another embodiment the water input and water output lines are comprised of PCV pipe.

In yet another embodiment the temperature control switch is operable to control the temperature of the water exiting the cylindrical shaped water tank.

In another embodiment the electrical flow switch is operable to control the flow of electricity to the electrical heating element.

In still another embodiment the electrical heating element is operable at 3500 watts and 240 volts.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a perspective view of an auxiliary water heater

FIG. 2 is a cross-sectional view of the auxiliary water heater of FIG. 1.

FIG. 3 illustrates a typical schematic of the auxiliary water heater of FIG. 1.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

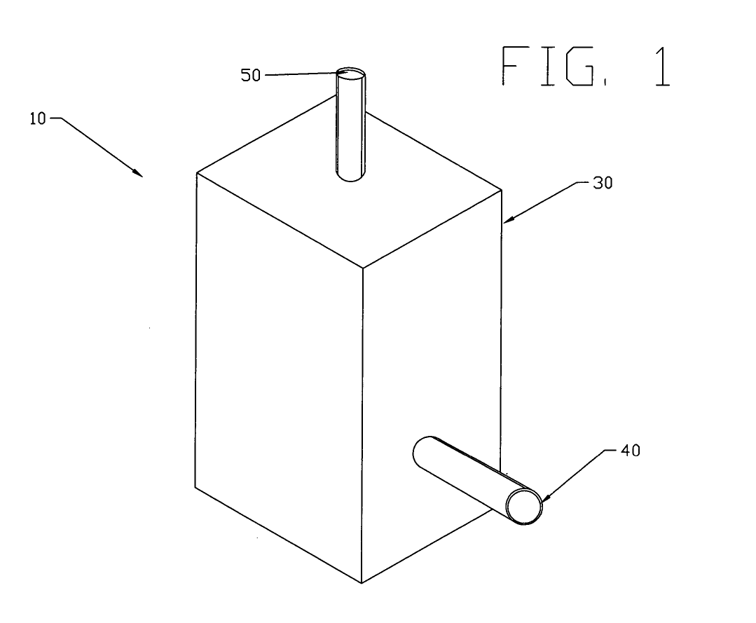

FIG. 1 is a perspective view of an auxiliary water heater 10 which comprises a cylindrical shaped water tank 20, an oblong case 30, a water input line 40, a water output line 50, an electrical heating element 60, an element port 70, an electrical flow switch 80, a thermal overload heater 90 and a temperature control switch 100. The cylindrical shaped water tank 20 is encased within the oblong case 30 which insulates and protects the cylindrical shaped water tank 20. The cylindrical shaped water tank 10 includes an electrical heating element 60 which operates to heat the water within the cylindrical shaped water tank 20. The electrical heating element 60 is inserted into the cylindrical shaped water tank 20 at the element port 70. The element port 70 then serves to supply electricity to the electrical heating element 60. Then the cylindrical shaped water tank 20 is installed into the existing water lines. The water input line 40 and the water output line 50 can be comprised a various types of material including copper or PVC pipe. Depending on the age of the water lines where the auxiliary water heater 10 is being installed the type of water lines that the auxiliary water heater 10 are being installed into with vary as well. While most of the newer homes are equipped with PVC pipe used as water lines, the older homes typically have copper pipe for water lines. The auxiliary water heater 10 should be installed as close to the faucet as feasibly possible. This will provide the quickest access to hot water when it is requested, because it limits the amount of travel time and potential for cool down during the flow process. Therefore, by installing the auxiliary water heater 10 into the existing water lines in someone's house, they can not only receive hot water at a faster rate but they can cut their water bills by eliminating the need to have the water flow from the faucet until the hot water reaches the faucet.

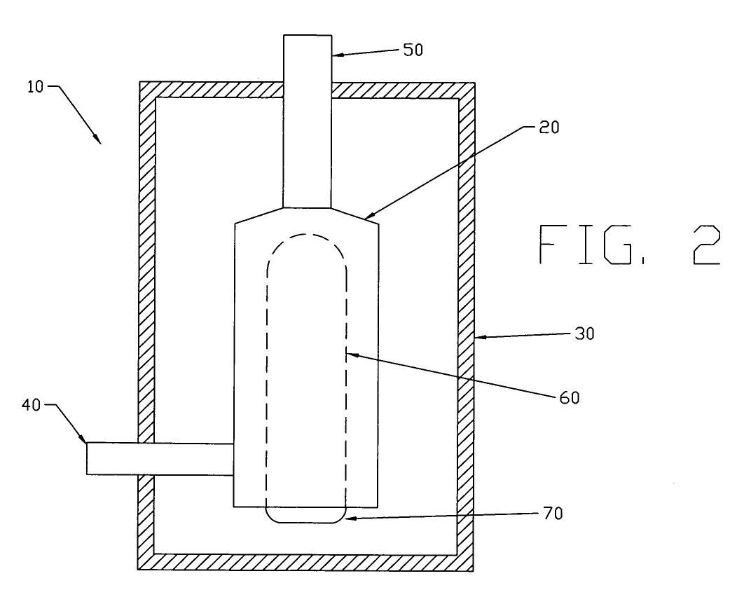

FIG. 2 illustrates a cross-sectional view of the auxiliary water heater 10, showing the oblong case 30 which is encompasses the cylindrical shaped water tank 20 while allowing the water input line 40 and the water output line 50 to extend outward from the oblong case 30. Additionally, the element port 70 is clearly defined to show how the electrical heating element 60 inserts up into the cylindrical shaped water tank 20. Once the electrical heating element 60 is engaged by turning on the faucet, the water brought into the cylindrical shaped water tank 20 through the water input 40 where it is heated and delivered out the water output line 50. Due to the close proximity of the auxiliary water heater 10 to the actual faucet, the user is capable of receiving hot water at a faster rate than receiving it from the normal hot water heater.

The electrical heating element 60 is designed to operate at 3500 watts or 240 volts. Therefore, in order to install the auxiliary water heater 10, an individual may be need to have additional electricity run to place or places of installation. Additionally, the electrical heating element 60 is designed with a typical temperature control switch 100 which allows the user to adjust the temperature of the water coming out of the auxiliary water heater 10 in much the same manner as is typically done with any regular hot water heater. Because the electrical heating element 60 is controlled by electricity, the auxiliary water heater is also equipped with safety measures.

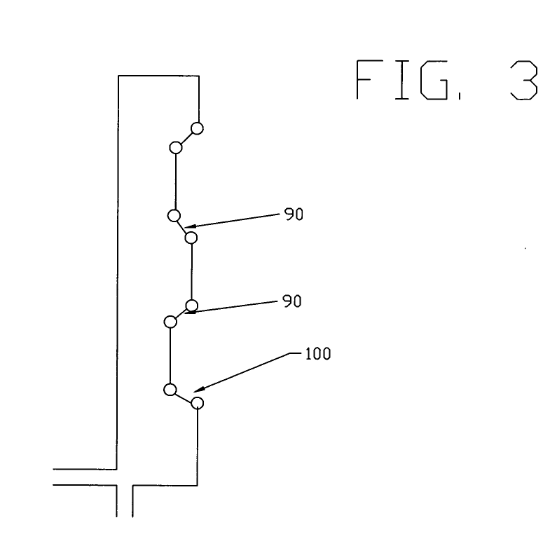

FIG. 3 is a typical schematic of the auxiliary water heater 10. It illustrates the thermal overload heater 90 which serves as a cut-off switch in the event of a malfunction in the electrical heating element 60 or within the element port 70 which serves to supply electricity to the electrical heating element 60. Additionally, FIG. 3 demonstrates the flow switch for the auxiliary water heater 10 and the temperature control switch 100.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. An auxiliary water heater comprising:
a cylindrical shaped water tank encompassed within an oblong case;
said cylindrical shaped water tank operable to attach to a water input line and a water output line;
an electrical heating element operable to heat water within said cylindrical shaped water tank;
an element port attached to said electrical heating element; wherein said element port is operable to supply power to said electrical heating element;
an electrical flow switch;
at least one thermal overload heater; and
a temperature control switch.

2. The auxiliary water heater of claim 1, wherein said water input line and said water output line is connected to the existing water lines.

3. The auxiliary water heater of claim 1, wherein said water input line and said water output line are comprised of copper.

4. The auxiliary water heater of claim 1, wherein said water input line and said water output line are comprised of PVC pipe.

5. The auxiliary water heater of claim 1, wherein said temperature control switch is operable to control the temperature of the water exiting said cylindrical shaped water tank.

6. The auxiliary water heater of claim 1, wherein said electrical flow switch is operable to control the flow of electricity to the electrical heating element.

7. The auxiliary water heater of claim 1, wherein said electrical heating element is operable at 3500 watts and 240 volts.

8. An in-line auxiliary water heater system comprising:
a cylindrical shaped water tank encompassed within an oblong case;
said cylindrical shaped water tank operable to attach to a water input line and a water output line;
an electrical heating element operable to heat water within said cylindrical shaped water tank;
an element port attached to said electrical heating element; wherein said element port is operable to supply power to said electrical heating element;
an electrical flow switch;
at least one thermal overload heater; and
a temperature control switch.

9. The in-line auxiliary water heater of claim 8, further comprising a temperature control switch operable to control the temperature of the water exiting said cylindrical shaped water tank.

10. The in-line auxiliary water heater of claim 8, wherein said water input line and said water output line is connected to the existing water lines.

11. The in-line auxiliary water heater of claim 8, wherein said water input line and said water output line are comprised of copper.

12. The in-line auxiliary water heater of claim 8, wherein said water input line and said water output line are comprised of PVC pipe.

13. The in-line auxiliary water heater of claim 9, wherein said electrical heating element is operable at 3500 watts and 240 volts.

14. A method for supplying hot water to a faucet comprising a cylindrical shaped water tank attached to a water input line and a water output line, an electrical heating element within said cylindrical shaped water tank, an element port operable to provide electric to said electrical heating element, an electrical flow switch, and a temperature control switch, comprising the steps of:
installing said cylindrical shaped water tank into the existing water lines as close to the faucet as feasibly possible;
attaching said heating element to said heating port;
supplying electricity to said heating port;
setting said temperature control switch;
engaging said electrical flow switch;
allowing time for the water to heat; and
turning on faucet.
